(19) United States
(12) Patent Application Publication
(10) Pub. No.: US 2024/0041016 A1
(43) Pub. Date: Feb. 8, 2024

(54) COMPACTABLE OBJECT REMOVER, GRASPER AND MULTI-USE TOOL

(71) Applicant: Reed Marquardt, Wyoming, MN (US)

(72) Inventor: Reed Marquardt, Wyoming, MN (US)

(21) Appl. No.: 18/231,711

(22) Filed: Aug. 8, 2023

Related U.S. Application Data
(60) Provisional application No. 63/370,703, filed on Aug. 8, 2022.

(51) Int. Cl. A01K 97/18; B25J 1/04; B25J 15/00

(52) U.S. Cl. CPC A01K 97/18; B25J 1/04; B25J 15/0019

(57) ABSTRACT

A separable grasping tool designed for grasping objects in hard to reach locations and able to be deconstructed to a small form factor for storage. The device includes a distal grasping portion and a proximal operating portion. The grasping tool may further include one or more intermediary portions disposed between the proximal and grasping portions, thereby extending an overall length of the tool. The device includes means to extend a gripping mechanism beyond a distal opening and to retract the gripping mechanism into the device. The device includes additional features for ease of use such as tethers to keep the device portions from being lost when separated and buoyant elements to float the device if dropped in water.

### CROSS-REFERENCE TO RELATED APPLICATIONS

This application claims priority to U.S. Provisional Application 63/370,703 filed on Aug. 8, 2022. The entirety of that application is incorporated by reference herein.

### FIELD OF THE DISCLOSURE

The present invention relates to devices for removing, dislodging, moving, and grasping objects. More specifically, the present invention relates to tools for removing stuck or embedded fishhooks from objects.

### BACKGROUND OF THE DISCLOSURE

When fishing, hooks get caught in all manner of objects. Hooks may get lodged in the captured fish and be rather difficult to remove. While working casting or otherwise working with hooks, hooks may get snared in other objects such branches, cushions, carpeting, even human flesh. Dislodging or moving an embedded hook can be extremely difficult without tools. Existing tools are typically awkwardly shaped making them difficult to store or transport. When travelling, such as on fishing expeditions or to other events in remote locations, saving space can be essential. Often tools do not fit into smaller tackle boxes. Tools suited for convenient travel often sacrifice functionality such as insufficient length or ineffective grasping portions. Tools that are too short cannot reach into narrow locations, such as the throat or stomach of a fish.

### SUMMARY

An effective grasping tool that can be easily deconstructed for storage and transportation would be welcomed by the industry. According to embodiments of the present disclosure, a device for grasping, dislodging, or moving objects that can be readily deconstructed and stored is disclosed.

In one or more embodiments a grasping tool comprises a distal grasping portion and a proximal operable portion. The distal grasping portion includes a first tubular outer shaft and a first interior shaft. The first tubular outer shaft includes a first central lumen. The first tubular outer shaft has a proximal opening and a distal opening. The first interior shaft has a distal tip and a proximal connecting portion. The first interior shaft is configured to slide within at least a portion of the first tubular outer shaft to change the relative position of the distal tip within the central lumen and provide for at least a portion of the distal tip to extend outward from the distal opening of the first tubular outer shaft at appropriate configurations of the distal tip.

The proximal operable portion comprises a second tubular outer shaft, a second interior shaft, a proximal end cap, and a retraction mechanism. The second tubular outer shaft has a second central lumen and a distal opening. The second interior shaft includes a distal connecting portion. The second interior shaft is configured to slide within at least a portion of the second tubular outer shaft to change the relative position of the distal connecting portion within the central lumen and provide for at least a portion of the distal connecting portion to extend outward from the distal opening of the second tubular outer shaft at appropriate configurations of the distal connecting portion. The proximal retraction mechanism comprises a spring biased to maintain the second interior shaft in an extended position. The second interior shaft comprises a cross-bar configured to compress the spring when pulled towards the proximal end cap and retract the distal tip within the central lumen of the first tubular outer shaft

In embodiments, the distal tip is a hook. In embodiments, the distal connecting section of the second interior shaft interfaces with the proximal connecting section of the first interior shaft such that sliding the second interior shaft causes the first interior shaft to slide a corresponding distance. In embodiments, the distal connecting section of the second interior shaft comprises a screw, and the proximal connecting section of the first interior shaft comprises a threaded bore configure to receive the screw. In embodiments, a proximal end of the first tubular shaft is configured to fit within the distal opening of the second tubular shaft. In embodiments, the proximal end of the first tubular shaft is crimped. In embodiments, the proximal end of the first tubular shaft is crimped.

In embodiments, the tool further comprises one or more intermediary portions. Each of the one or more intermediary portions comprises an intermediary tubular outer shaft having an intermediary central lumen, a proximal opening and a distal opening. The intermediary interior shaft has a distal connecting portion and a proximal connecting portion. The intermediary interior shaft is configured to slide within at least a portion of the intermediary tubular outer shaft to change the relative position of the distal connecting section within the central lumen and provide for at least a portion of the distal connecting section to extend outward from the distal opening of the intermediary tubular outer shaft at appropriate configurations of the distal connecting section. The one or more intermediary portions are connected between the distal grasping portion and the proximal operable portion.

In embodiments, the cross-bar extends through a slot in the in the second interior shaft, the slot having a length that defines the distance the second interior shaft can travel within the central lumen. In embodiments, a collar surrounds the second tubular shaft, the collar having an opening through which the cross bar extends. In embodiments, the collar comprises a foldable arm.

In one or more embodiments, a deconstructable grasping device includes a tubular shaft, a central shaft, and a lever. The tubular shaft has a central lumen. The central shaft is disposed within the central lumen. The central shaft includes a distal grasping mechanism. The is at a proximal end portion of the tubular shaft. The lever is configured to slide the central shaft within the central lumen such that pushing the lever distally extends the distal grasping mechanism beyond a distal opening of the tubular shaft, and pulling the lever proximally retracts the grasping mechanism within the central lumen. The tubular shaft and central shaft are separable into at least a proximal operable portion and a distal grasping portion.

In embodiments, the tubular shaft and central shaft are further separable into one or more intermediary portions. In embodiments, the lever extends outwardly through a slot in the in the tubular shaft, the slot having an axial length defining a length of travel of the central shaft. In embodiments, a spring maintains the lever in an extended position. In embodiments, the device further includes retention means configured to retain the central shaft within the tubular shaft. In embodiments, the retention means is buoyant.

A method of using a grasping tool comprises providing a grasping tool; joining the distal grasping portion to the proximal operable portion; grasping an object with the distal tip; and withdrawing the distal tip into the central lumen. In embodiments, the method further comprises the step of extending a length of the grasping tool by inserting one or more intermediary portions between the distal grasping portion and the proximal operable portion. In embodiments, the method further comprises the step of deconstructing the grasping tool by separating the distal grasping portion from the proximal operable portion.

A feature and advantage of embodiments of the disclosure is a tool that can be readily deconstructed for storage in minimal space. A feature and advantage of embodiments of the disclosure is a tool that can extend into narrow or hard to reach locations. A feature and advantage of embodiments of the disclosure is a tool is a tool that can be tethered for easy reach when the tool is needed. A feature and advantage of embodiments of the disclosure is a tool whose components can be tethered to one another to prevent loss. A feature and advantage of embodiments of the disclosure is a tool having plugs or seals to prevent contaminants from entering the tool. A feature and advantage of embodiments of the disclosure is a tool that is buoyant to prevent loss when falling into a body of water.

### BRIEF DESCRIPTION OF THE DRAWINGS

The drawings included in the present application are incorporated into, and form part of, the specification. They illustrate embodiments of the present disclosure and, along with the description, explain the principles of the disclosure. The drawings are only illustrative of certain embodiments and do not limit the disclosure. Embodiments of the invention will be described with respect to the figures, in which like reference numerals denote like elements, and in which:

FIG. 1A is a side view of a grasping tool according to one or more embodiments of the invention;

FIG. 1B is a side view of the grasping tool of FIG. 1A in a deconstructed configuration;

FIG. 1C is a side view of a grasping tool according to one or more embodiments of the invention;

FIG. 1D is a side view of the grasping tool of FIG. 1C in a deconstructed configuration;

FIG. 2A is a side cross-sectional view of a grasping tool according to one or more embodiments of the invention;

FIG. 2B is a side cross-sectional view of a grasping tool according to one or more embodiments of the invention;

FIG. 3A is an enlarged side cut away view of the proximal end of a grasping tool according to one or more embodiments of the invention;

FIG. 3B is an enlarged perspective cut away view of the proximal end of a grasping tool with a handle in a closed position according to one or more embodiments of the invention;

FIG. 3C is an enlarged perspective cut away view of the proximal end of a grasping tool with a handle in an open position according to one or more embodiments of the invention;

FIG. 4A is an enlarged perspective cut away view of a connecting section of a grasping tool according to one or more embodiments of the invention;

FIG. 4B is an enlarged perspective view of the device of FIG. 4A from an alternative direction;

FIG. 5A is a partial perspective cross sectional view of a distal end of a device having retention means according to one or more embodiments of the invention;

FIG. 5B is an enlarged partial view of the device of FIG. 5A;

FIG. 6A is a partial side cut away view of a distal end of a device having retention means according to one or more embodiments of the invention;

FIG. 6B is a perspective view of the device of FIG. 6A; and

FIG. 6C is a perspective cut away view of a distal end of a device having retention means according to one or more embodiments of the invention.

FIG. 7A is a side cut away view of a grasping tool according to one or more embodiments of the invention;

FIG. 7B is an enlarged perspective cut away view of the grasping portion of the device of FIG. 7A;

FIG. 7C is an enlarged perspective view of the device of FIG. 7B from an alternative direction;

FIG. 7D is an enlarged perspective cut away view of the proximal portion and the device of FIG. 7A;

FIG. 8A is a side cut away view of a grasping tool according to one or more embodiments of the invention;

FIG. 8B is an enlarged side cut away view of the grasping portion of the device of FIG. 8A;

FIG. 8C is an enlarged perspective cut away view of the grasping portion of the device of FIG. 8A;

FIG. 8D is an enlarged perspective view of the device of FIG. 8C from an alternative direction;

FIG. 8E is an enlarged perspective cut away view of the proximal portion and the device of FIG. 8A;

FIG. 8F is an enlarged perspective cut away view of the connecting section circled in FIG. 8E.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention.

### DETAILED DESCRIPTION

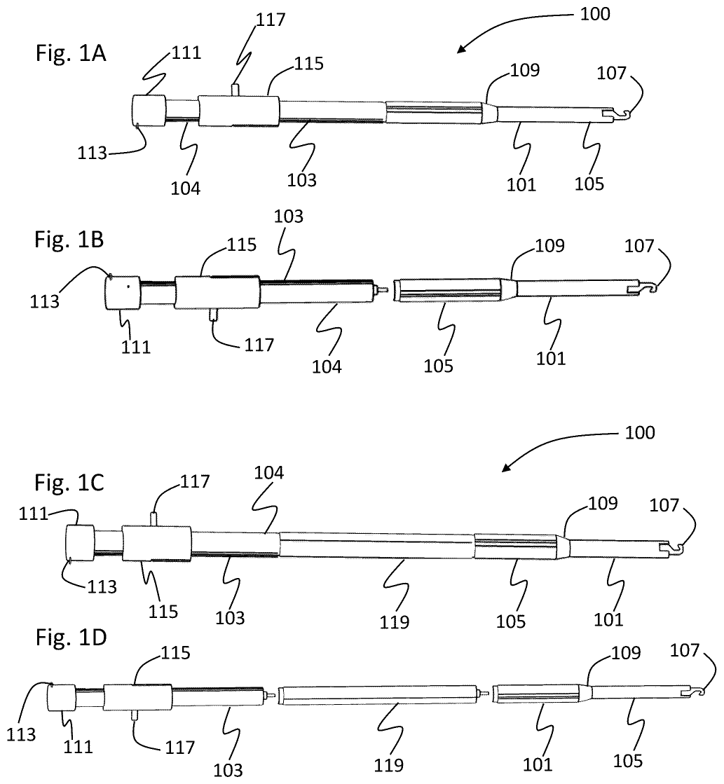

Referring to FIGS. 1A and 1B, a grasping tool 100 is shown having a grasping portion 101 and a proximal portion 103. As shown in FIG. 1B, grasping tool 100 may be deconstructed by separating the grasping portion 101 from the proximal portion 103. Grasping portion 101 has a tubular shaft 105 and a grasping mechanism, such as a distal hook 107. In embodiments, tubular shaft may have a tapered portion 109. Proximal portion 103 has a tubular shaft 104 and an end cap 111. In some embodiments, end cap 111 may include a ring 113 for receiving a tether, rope, or the like. Securing the grasping tool 100 to a tether aids in loss prevention. Further, a tether might be worn around the wrist or hooked to a belt loop, keeping the tool nearby when needed, such as immediately after reeling in a fish with a lodged hook. A slidable collar 115 surrounds a section of the proximal portion 103. As discussed in more detail below, part of an interior shaft projects outwardly through the collar 115, acting as a lever 117 to slide the distal hook 107 along the central axis of grasping tool 100. Although a hook is shown, other grasping mechanisms such as barbs, spikes, claws, or the like are not beyond the scope of this disclosure.

Referring to FIGS. 1C and 1D, grasping tool 100 is shown with an intermediary portion 119 disposed between the grasping portion 101 and proximal portion 103. Separation and joining of the grasping, proximal, and any intermediary portions will be discussed in more detail below. One skilled in the art will recognize that any number of intermediary portions 119 may be used to lengthen the grasping tool 100. Further, intermediary portions may have various lengths. In some embodiments, having multiple, shorter intermediary portion 119 allows the deconstructed device to fit into and be transported by smaller tackle boxes or the like.

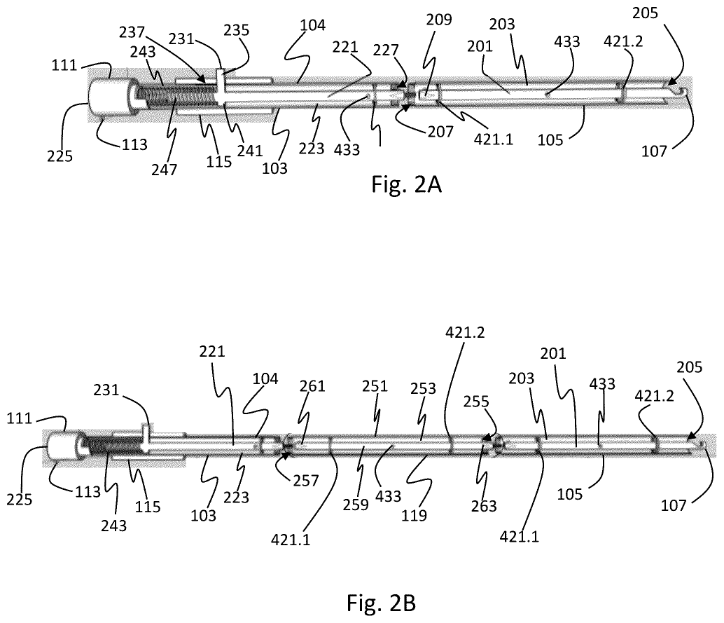

FIG. 2A depicts a cross-sectional view of the device of FIG. 1B, and FIG. 2B depicts a cross-section view of the device of FIG. 1D. As shown, grasping portion 101 has an inner shaft 201 disposed within a central lumen 203 of tubular outer shaft 105. Outer shaft 105 has a distal opening 205 and a proximal opening 207. Distal hook 107 is shown extending beyond a distal opening 205 of the tubular outer shaft 105. When the inner shaft 201 is retracted, distal hook 107 is pulled within the central lumen 203 of tubular outer shaft 105. Inner shaft 201 includes a connecting section 209 at a proximal end of the shaft. The tubular outer shaft 105 further includes means of retaining the inner shaft 201 within the central lumen 203, so that the shaft 201 does not fall out of either the distal or proximal openings 205, 207 of the outer shaft 105, that will be explained in more detail below.

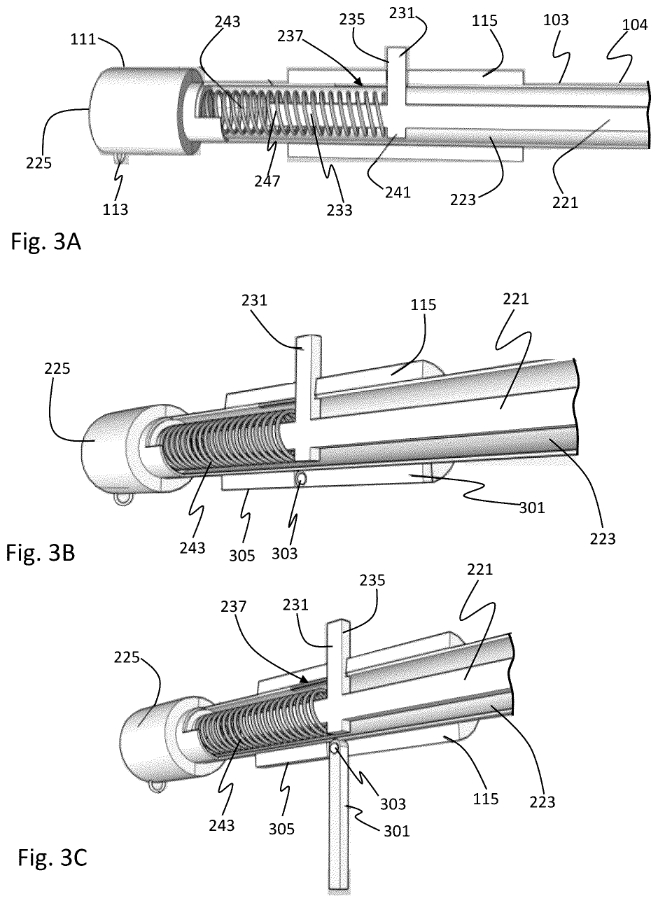

Proximal portion 103 has an inner shaft 221 disposed within a central lumen 223 of the outer shaft 104 and a distal connecting section 229. The outer shaft 104 has a distal opening 227 and a proximal end cap 225. As depicted in the enlarged view in FIG. 3A, the inner shaft 221 has a leg 231 offset from the proximal end 233 of the shaft 221, the leg 231 being generally orthogonal to the inner shaft 221. A longer portion 235 of the leg 231 projects outwardly through a slot 237 in the outer shaft 104 and may function as a lever 117 for translating the inner shaft 221 within the central lumen 223. A shorter portion 241 of the leg 231 is retained within the central lumen 223 of the outer shaft 103. A spring 243 within the central lumen 223 of the proximal portion 103 is sandwiched between the end cap 225 and the leg 231 and is biased to push the inner shaft 221 in the proximal direction. In embodiments, a distal section 247 of the inner shaft 221 extends distally of the leg 231 and into a central cavity of the spring 243. In some embodiments, a collar 115 may surround the outer shaft 103. The collar 115 may have an aperture through which the leg 231 extends. Accordingly, the collar 115 and leg 231 slide in unison when transitioning the device between a retracted and an extended configuration. It will be appreciated that the axial length of the slot 237 in the outer tube 103 is directly associated with a distance that the inner shaft 221 can travel within the central lumen 223. Referring specifically to FIGS. 3B and 3C, in some embodiments, the collar 115 may include a retractable handle 301. In some embodiments, in a stowed position, the retractable handle 301 may fit within a recess in the collar 115 and be generally flush with an outer surface 305 of the collar 115. In some embodiments, the handle 301 may swing out from a fixed pivot point 303. The pivot point 303 may be aligned with the aperture in the collar such that when the handle 301 is extended, it is generally aligned with the leg 231 of the inner shaft 221. The handle may facilitate use of the device and make it easier to retract the grasping mechanism.

Referring back to FIG. 2, in some embodiments, an intermediary portion 119 is disposed between the proximal portion 103 and the grasping portion 101. The intermediary portion 119 includes a tubular shaft 251 with a central lumen 253 and both distal and proximal openings 255, 257, and an inner shaft 259 within the central lumen 253. The inner shaft 259 has a proximal connecting section 261 and a distal connecting section 263. The outer shaft 259 includes means to retain the inner shaft 259 within the central lumen 253 without preventing the inner shaft 259 from sliding along the central axis. The connecting sections and retention means are discussed in further detail below. The connecting sections may be used to connect to additional intermediary portions, the grasping portion, or the proximal portion of the device. Additional intermediary portions may be used to extend an overall length of the device which may assist with reach, particularly into long narrow cavities that are otherwise not readily accessible. The use of multiple, shorter intermediary portions to attain a desired overall length of the device may also advantageously allow for a shorter deconstructed length of the device, thereby facilitating storage and/or transportation of the device.

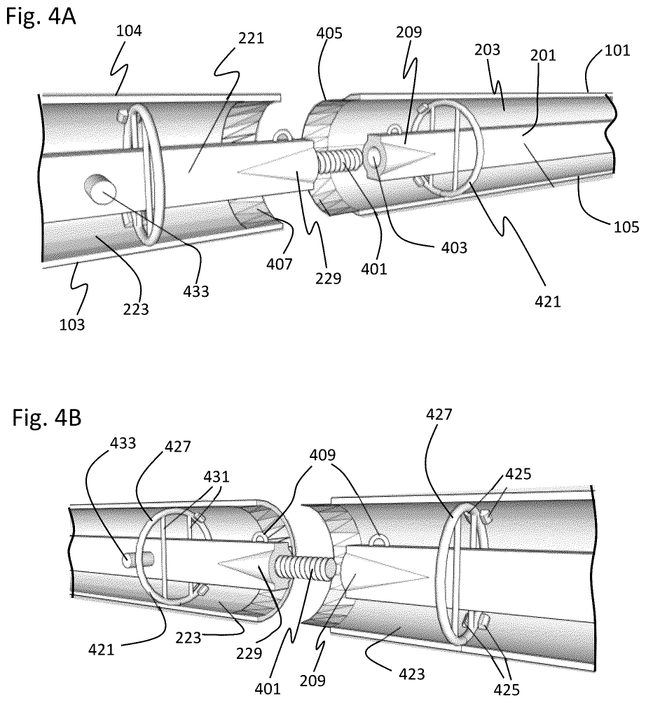

Referring to FIGS. 4A and 4B, enlarged perspective views show two angles of an embodiment of connecting sections of the device and an embodiment of retention means. Although the figures are described with reference to connecting the proximal portion 105 to the grasping portion 103, it should be recognized that the same configuration applies to the intermediary portions 119. In embodiments, the connecting section 229 of the inner shaft 221 of the proximal portion 103 includes a distally projecting screw 401. The connecting section 209 of the inner shaft 201 of the grasping portion 101 comprises a bore 403 configured to receive the screw 401. It should also be recognized that the screw and bore could be reversed. That is, the grasping portion could have the screw and the proximal portion could have the bore to receive the screw. A proximal end 405 of the outer shaft 105 of the grasping portion 101 is configured to fit within a distal end 407 of the outer shaft 104 of the proximal portion 103. For example, the proximal end of the grasping portion may be tapered, crimped, have a thinner wall, or the like. As noted above with respect to the connecting sections of the inner shafts, in embodiments, the corresponding portions of the outer shafts could be reversed. That is, the outer shaft of the proximal portion could be configured to fit within the outer shaft of the grasping portion. Once joined, the shafts form generally contiguous elements. The outer shaft of the assembled device has a generally continuous outer surface and a continuous central lumen extending from the proximal end cap to the distal opening of the grasping section. The inner shafts form a continuous shaft such that sliding the lever near the proximal end of the device will cause the distal grasping mechanism to extend beyond the outer shaft or withdraw into the central lumen. Adding any number of intermediary portions merely extends the length of the shafts without altering the functionality described above. In embodiments, the connecting sections 209, 229 of the inner shafts may include loops or rings 409 affixed to the shaft. These may be used to connect tethers, such as ropes, strings, chains, or the like, linking the portions of the device to one another. Tethering portions together permits the portions to stowed in a compact manner when deconstructed while preventing accidental loss or misplacement of portions of the device. Although screws and cooperating bores are shown for joining the inner shafts together, other connection means are not beyond the scope of this disclosure. Other connection means include, but are not limited to, magnets, hinges, buckles, or the like.

An embodiment of a retention mechanism is depicted shown to prevent the entire inner shaft 201, 221 from falling out of the outer shaft 104, 105. In embodiments, a grate 421 is affixed to an inner wall 423 of the outer shaft, such as by one or more retention clips 425, the grate extending across the central lumen. In embodiments, grates may be placed near openings of the outer shaft. For example, as seen in FIGS. 2A and 2B, proximal portion 103 has one grate 421 near the distal opening 227 of the outer shaft 104, and each of the intermediary 119 and grasping portions 101 have two grates 421 including a first grate 421.1 near the proximal opening 207, 257 of the outer shaft 105, 251 a second grate 421.2 near the distal opening 255, 205 of the outer shaft 105, 251. In embodiments, the grate 421 may have a circular outer frame 427 confirming to the inner wall 423 of the shaft, and parallel bars 431 having ends affixed to the circular outer frame 427, defining two or more passages through the grate. In embodiments, the inner shaft 201, 221, 259 may fit within one of the passages through the grate 421. In embodiments, the grate 421 may have two bars 431 defining a generally rectangular central passageway, and the inner shaft 201, 221, 259 may have a generally rectangular cross-section conforming to the central passageway. The inner shaft 201, 221, 259 may include one or more outwardly extending nubs 433 that protrude beyond a width of the passageway of the grate. Accordingly, when the inner shaft slides through the grate, the nub will strike one of the bars on the grate and act as a stop preventing the inner shaft from travelling further beyond the grate. Additional nubs may further limit the range of motion of the inner shaft.

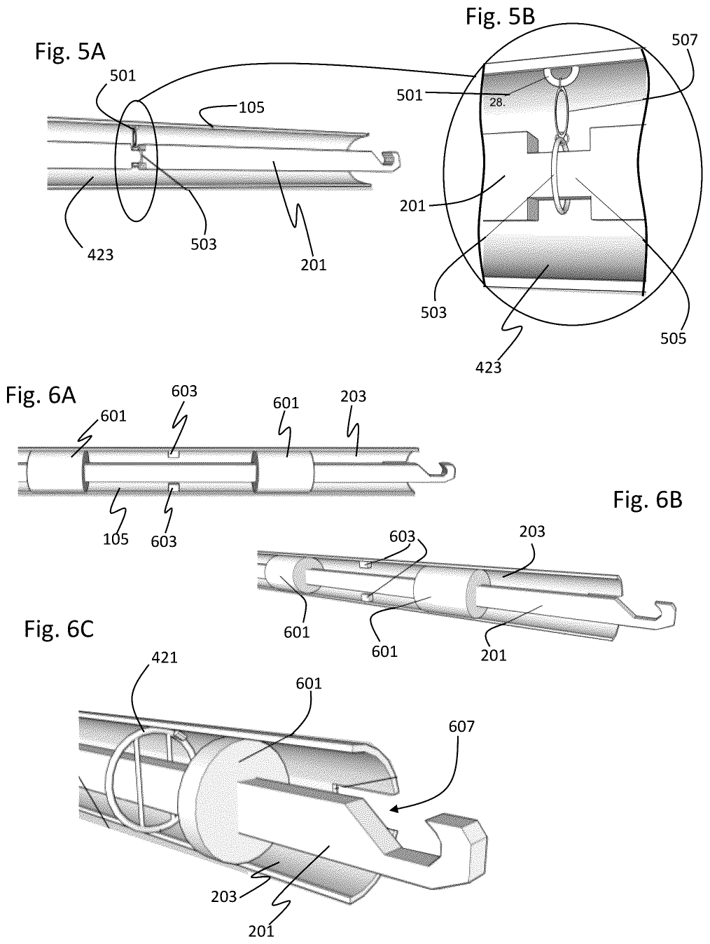

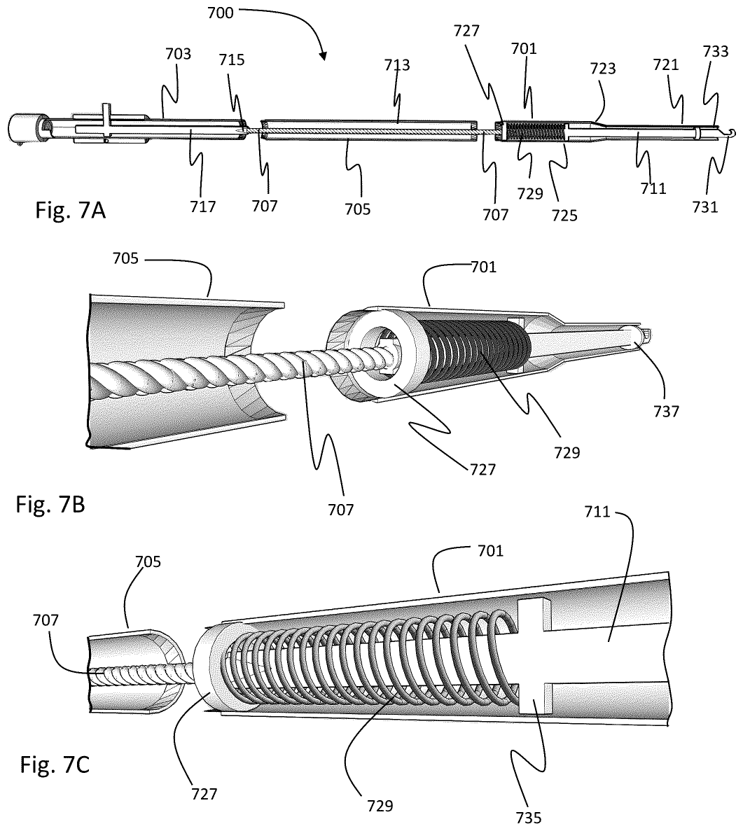

FIGS. 5 and 6 show further exemplary embodiments of retention means. Although these exemplary embodiments are shown with respect to the grasping portion, it will be understood that these retention means could be used elsewhere in the device for retaining similar elements, such as in the intermediary portion or the proximal portion. Referring to FIGS. 5A and 5B, inner shaft 201 may be tethered to the outer shaft 105. For example, a loop or ring 501 may be affixed to the inner wall 423 of the outer shaft 105. A corresponding loop or ring 503 may encircle a recessed or crimped portion 505 of the inner shaft 201. The rings may then be linked 507, such as by a chain, rope, string, loop, or the like. Slack in the linkage permits motion of the inner shaft, thereby allowing the grasping mechanism to extend beyond the distal opening of the outer shaft or be pulled within the central lumen.

FIGS. 6A and 6B depict an embodiment of retention means using one or more plugs 601 surrounding the inner shaft 201. One or more nubs 603 may be affixed to the inner wall 423 of the outer shaft 105. The one or more nubs 603 act as stops for the plugs, thereby restricting lateral movement of the inner shaft 201 within the central lumen 203. As seen in FIG. 6C, a grate 421 may be used instead of, or in conjunction with, nubs 603 to act as a stop for the plug 601. Plugs 601 may be sized to allow for sliding within the central lumen 203 while acting as a barrier for dirt, debris, moisture, or other undesirable contaminants from entering the central lumen of an assembled device. Any of the discussed, as well as other similar, retention means may provide varying degrees of stability to the assembled device such as by limiting the ability of the inner shaft to torque within the central lumen. FIG. 6C further depicts an optional slot 607 at the distal end of the outer shaft 105 that may permit the grasping tool to more securely grasp and retain objects.

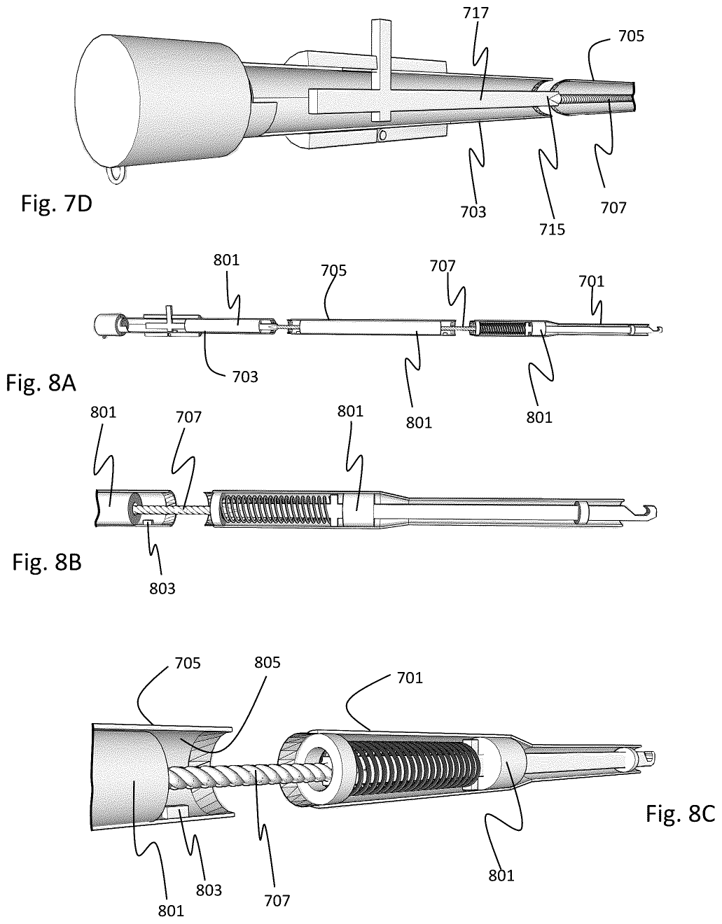

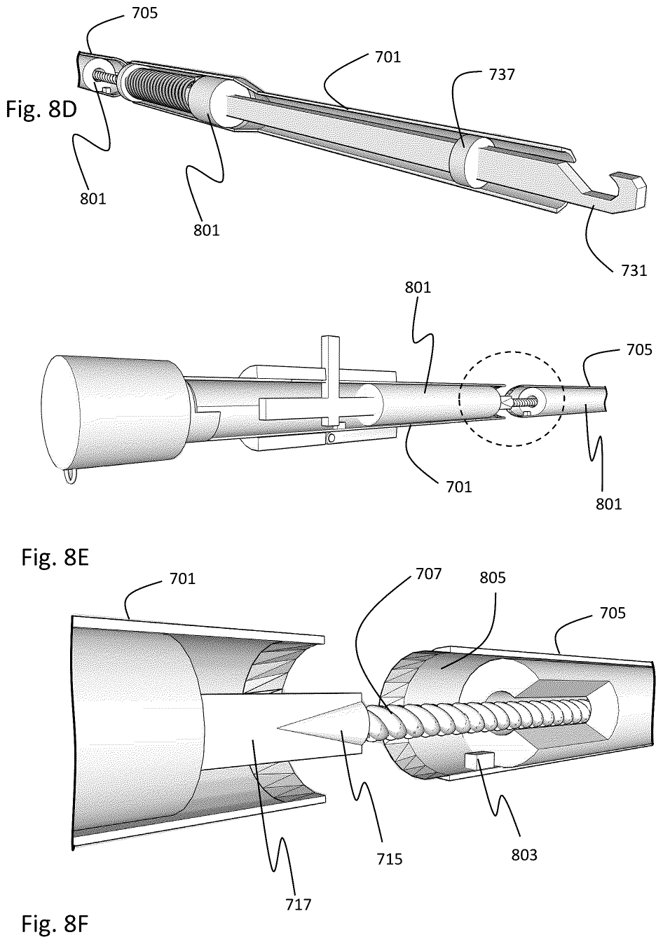

Referring to FIGS. 7 and 8, an alternative embodiment of the device 700 is depicted having a grasping portion 701, a proximal portion 703, and an intermediary portion 705. In comparison to the above disclosed embodiments, in the presently described embodiments the generally rigid inner shaft of the intermediary portion disclosed above is replaced with a rope or flexible cord such as an elastic cord or bungee cord 707. Cord 707 extends from the connecting section 709 of the inner shaft 711 of the grasping portion, through the central lumen 713 of the intermediary section, and terminates at the connecting section 715 of the inner shaft 717 of the proximal portion 703. Referring to FIGS. 7A-7C, in embodiments, grasping portion 701 includes a narrow forward portion 721, a tapered portion 723, and a spring chamber 725 housing a stopper 727 and compression spring 729 biased to push grasping mechanism 731 from a distal tip 733 of the device. Stopper 727 acts as a holding point for the proximal end of the spring 729. Inner shaft 711 has a cross-member 735 at a distal end of the spring such that pulling the inner shaft proximally will compress the spring and retract the grasping mechanism, and releasing the inner will allow the spring to uncompress and push the cross-member, and accordingly the inner shaft and grasping mechanism, in the distal direction. As such, pulling the proximal portion 703 will retract the grasping mechanism 731 into the device, and releasing the proximal portion 703 will cause the grasping mechanism to extend beyond the distal opening 733 of the device. Forward plug 737 may prevent debris or other unwanted contaminants from entering the device. To deconstruct the device, the proximal and grasping portions 701, 703 may be pulled in opposite directions extending the cord 707 and creating separation at both ends from intermediary portion 705. The grasping and proximal portions 701, 703 may then be folded toward the intermediary portion 705. The resulting bend in the cord 707 will prevent it from retracting, and the device will remain in a compact position for storage or transport.

Referring to the embodiments of FIGS. 8A-8E, plugs 801 may be added in some or all open spaces in the central lumen for additional support. Plugs 801 may be generally cylindrical to conform to the interior of the central lumen. In embodiments, plugs 801 may slide within the central lumen. In embodiments, plugs 801 may have central openings or lumens allowing the inner shaft and/or cord to slide through the plug 801 without the plug 801 moving. In embodiments, one or more nubs or stoppers 803 may be affixed to inner walls 805 of the outer shaft 807 to prevent the plug 801 from moving. For example, nubs 803 may be placed near openings of the outer shaft 805.

The grasping tool may be comprised of various materials including, but not limited to, extruded metals, plastics, foams or the like. Combinations of materials are not beyond the scope of this disclosure. For example, the outer shaft may be an extruded polymer or plastic while the inner shaft might be metallic, such as aluminum or stainless steel. In embodiments, some materials such as the retention means, may be selected for particular properties such buoyancy. It may be advantageous to construct the device in a manner allowing it to float if accidently dropped in water, such as overboard from a boat.

Although the present invention has been described with reference to particular embodiments, those skilled in the art will recognize that changes may be made in form and substance without departing from the spirit and scope of the invention. The embodiments described above are intended to be illustrative and not limiting.

1. A grasping tool comprising:
a distal grasping portion comprising
a first tubular outer shaft comprising a first central lumen, the first tubular outer shaft having a proximal opening and a distal opening; and
a first interior shaft having a distal tip and a proximal connecting portion, the first interior shaft configured to slide within at least a portion of the first tubular outer shaft to change a relative position of the distal tip within the central lumen and provide for at least a portion of the distal tip to extend outward from the distal opening of the first tubular outer shaft at appropriate configurations of the distal tip; and
a proximal operable portion comprising
a second tubular outer shaft comprising a second central lumen, the second tubular outer shaft having a distal opening, a proximal end cap, and a retraction mechanism; and
a second interior shaft having a distal connecting portion, the second interior shaft configured to slide within at least a portion of the second tubular outer shaft to change a the relative position of the distal connecting portion within the central lumen and provide for at least a portion of the distal connecting portion to extend outward from the distal opening of the second tubular outer shaft at appropriate configurations of the distal connecting portion,
wherein the proximal retraction mechanism comprises a spring biased to maintain the second interior shaft in an extended position; and the second interior shaft comprises a cross-bar configured to compress the spring when pulled towards the proximal end cap and retract the distal tip within the central lumen of the first tubular outer shaft.

2. The grasping tool of claim 1, wherein the distal tip is a hook.

3. The grasping tool of claim 1, wherein the distal connecting section of the second interior shaft interfaces with the proximal connecting section of the first interior shaft such that sliding the second interior shaft causes the first interior shaft to slide a corresponding distance.

4. The grasping tool of claim 1, wherein the distal connecting section of the second interior shaft comprises a screw, and the proximal connecting section of the first interior shaft comprises a threaded bore configure to receive the screw.

5. The grasping tool of claim 1, wherein a proximal end of the first tubular shaft is configured to fit within the distal opening of the second tubular shaft.

6. The grasping tool of claim 5, wherein the proximal end of the first tubular shaft is crimped.

7. The grasping tool of claim 5, wherein the proximal end of the first tubular shaft is crimped.

8. The grasping tool of claim 1 further comprising one or more intermediary portions, each of the one or more intermediary portions comprising an intermediary tubular outer shaft comprising an intermediary central lumen, the intermediary tubular outer shaft having a proximal opening and a distal opening; and
an intermediary interior shaft having a distal connecting portion and a proximal connecting portion, the intermediary interior shaft configured to slide within at least a portion of the intermediary tubular outer shaft to change the relative position of the distal connecting section within the central lumen and provide for at least a portion of the distal connecting section to extend outward from the distal opening of the intermediary tubular outer shaft at appropriate configurations of the distal connecting section.
wherein the one or more intermediary portions are connected between the distal grasping portion and the proximal operable portion.

9. The grasping tool of claim 1, wherein the cross-bar extends through a slot in the in the second interior shaft, the slot having a length that defines the distance the second interior shaft can travel within the central lumen.

10. The grasping tool of claim 1, wherein a collar surrounds the second tubular shaft, the collar having an opening through which the cross bar extends.

11. The grasping tool of claim 10, wherein the collar comprises a foldable arm.

12. A deconstructable grasping device comprising:
a tubular shaft with a central lumen;
a central shaft within the central lumen, the central shaft comprising a distal grasping mechanism; and
a lever at a proximal end portion of the tubular shaft, the lever configured to slide the central shaft within the central lumen such that pushing the lever distally extends the distal grasping mechanism beyond a distal opening of the tubular shaft, and pulling the lever proximally retracts the grasping mechanism within the central lumen,
wherein the tubular shaft and central shaft are separable into at least a proximal operable portion and a distal grasping portion.

13. The deconstructable device of claim 12, wherein the tubular shaft and central shaft are further separable into one or more intermediary portions.

14. The deconstructable device of claim 12, wherein the lever extends outwardly through a slot in the in the tubular shaft, the slot having an axial length defining a length of travel of the central shaft.

15. The desconstructable device of claim 12, wherein a spring maintains the lever in an extended position.

16. The deconstructable device of claim 12, further comprising retention means configured to retain the central shaft within the tubular shaft.

17. The deconstructable device claim 16, wherein the retention means is buoyant.

18. A method of using a grasping tool comprising:
providing the grasping tool of claim 1;
joining the distal grasping portion to the proximal operable portion;
grasping an object with the distal tip; and
withdrawing the distal tip into the central lumen.

19. The method of claim 18, further comprising:
extending a length of the grasping tool by inserting one or more intermediary portions between the distal grasping portion and the proximal operable portion.

20. The method of claim 18, further comprising:
deconstructing the grasping tool by separating the distal grasping portion from the proximal operable portion.
